(19) United States
(12) Patent Application Publication
(10) Pub. No.: US 2002/0097178 A1
(43) Pub. Date: Jul. 25, 2002

(54) System and method to attribute, reconcile and account for automated vehicle identification charges irrespective of vehicle ownership

(76) Inventors: Warren J. Thomas JR., Tulsa, OK (US); Lonna M. Thomas, Tulsa, OK (US)

Correspondence Address: HEAD, JOHNSON & KACHIGIAN, 228 W 17TH PLACE, TULSA, OK, 74119, US

(21) Appl. No.: 09/766,324

(22) Filed: Jan. 19, 2001

(51) Int. Cl. G06F 17/60; G01S 13/08

(52) U.S. Cl. 342/47; 705/13

(57) ABSTRACT

The invention is directed towards a system and business process which provides for reconciliation and accounting services necessary to support automated vehicle identification (AVI) tag utilization irrespective of vehicle owner. A plurality of AVI's, alternatively referred to as “Toll Tags” are acquired and such tags are registered with a centralized reconciliation and accounting entity. The acquired tags are then physically affixed to a motor vehicle within a multiple vehicle entity's fleet. The invention digitally acquires and combines charges attributed to tag usage, with information relating to transient drivers utilizing the fleet's vehicles who have incurred charges during a period of vehicle utilization. The instant invention then provides via its integrated software processes a reconciliation methodology by which applicable charges are created in the form of a bill which can be submitted or billed as credit charges to, and recovered from, responsible parties with fees and rebates attendant thereto rendered to selected entities.

### BACKGROUND OF THE INVENTION

1. Field of the Invention

The present invention relates generally to systems for vehicle toll collection. In particular, the present invention is directed to a system and method to provide reconciliation and accounting services associated with automated vehicle identification tags (AVI) utilization irrespective of vehicle ownership or transient driver utilization.

2. Prior Art

Vehicle identification and toll collecting systems and limited improvements to such systems are well represented in the art. For example:

U.S. Pat. No. 4,555,618 issued on Nov. 26, 1985 to Bernard N. Riskin, subsequently assigned to R. L. Associates, discloses a method and means for collecting highway tolls. This system is especially adapted for facilitating the collection of tolls on highways, includes the provision of visible bar codes or other machine-readable customer account identifications, on vehicles using toll roads. Issuance of the account identification elements enables the customer to pass assigned scanning locations where the elements are machine-read, and verified at a computerized station serving a selected number of scanning locations.

U.S. Pat. No. 5,819,234 issued on Oct. 6, 1998 to Fred Slavin and Randy J. Schafer, subsequently assigned to The Chase Manhattan Bank, discloses a toll collection system. An automatic toll collection system comprises and operates in conjunction with transponders which are provided for sale to the public in sealed packages and which are pre-approved for a predetermined amount of prepaid toll credit. When the transponders are purchased, they can be installed in any vehicle and are immediately ready for use. The kit in which the transponder is sold includes application forms and a return mailer which permit the purchaser thereof to convert the preestablished anonymous account to a regular prepaid toll account and to authorize the automatic replenishment of the account, thus enabling continued use of the purchased transponder beyond the pre-approved amount. The invention further comprises the process offrequent updating, e.g. several times daily, hourly, etc. of toll plaza computers with toll transactions at all participating toll facilities, to prevent inadvertent overdrawing of toll accounts by motorists.

3. Current Invention

The instant invention takes advantage of the widespread use of credit cards, and the proliferation of so-called “credit card companies” issuing cards used to make purchases of an almost limitless variety, clearly making it desirable to offer an AVI system wherein the driver of a leased or rented vehicle would automatically, and with maximum convenience, be billed by the driver's credit grantor or other third party on a regular monthly statement for any AVI charges incurred during the period of time a vehicle was leased or rented by the driver. It is clear that contemporary AVI systems lack such capability and it is to this deficiency the present invention directs itself.

The instant invention eliminates toll violations by rental drivers. When a rental or leased vehicle violates or otherwise passes a toll interchange without paying, many employee hours are needlessly expended in that the toll authority must notify the registered owner of the car, here the rental or leasing agency, that a violation has occurred. In turn, the agency must then search its records to determine who rented the car at the particular time of the toll violation and then submit the name, address and phone number of the customer renting the vehicle at the time of the violation to the toll authority. Subsequently, the toll authority must notify the customer and collect the toll due as well as any appropriate fines. Should the customer elect not to respond to the toll authority, the authority must notify the registered owner, here the rental agency, to collect the tolls due as well as any appropriate fines. It is clear such toll violations waste time, money and clearly jeopardize customer satisfaction not only with a vehicle leasing/rental agency but with a toll authority. Rental customers become embarrassed, frustrated and understandably leave the city with an unfavorable vehicle rental experience. Both the rental agency and toll authority spend needless time and energy processing alleged violation(s). This invention will eliminate toll violations by rental drivers using the invention.

An object of the present invention, intended to overcome the deficiencies in the prior art systems, is to offer a system whereby multiple vehicle leasing facilities, such as car rental agencies, would be able to offer the convenience of AVI usage to drivers of leased or rented vehicles. Yet another object of the instant invention is to eliminate the need of individual drivers to own AVI devices in every toll area they travel or to pay cash for tolls while in rental/leased vehicles.

Another object, especially for business users, is to automatically provide, for the business motorist, a consolidated receipt and permanent record of the transaction to facilitate charging of the toll as a business expense notwithstanding how many different vehicles/places he has incurred AVI expenses. To this end, the invention is so designed as to provide automatic recordation of tolls charged, not only for individual motorists, but also for the operators of vehicle leasing fleets, such as automobile and truck rental agencies. Such fleet operators are enabled, in accordance with the invention, to have a complete record of the exact times and amounts of recorded tolls incurred by individual drivers of their fleet vehicles or individual drivers of their leased vehicles.

A further object is to provide, for a leased vehicle owner or driver, a complete record usable in justification of business travel expenses, for such purposes as supporting tax returns and obtaining reimbursement for the expenses incurred.

Yet another object is to facilitate the calculation and granting of highway toll authority discounts.

An additional object is to provide an advantage for a toll road authority or the like, in that funds will be transferred to the authority directly to the bank used by them, through electronic fund transfer on a regular basis.

An additional object of the instant invention is to consolidate the accounting of multiple AVI devices, registered or issued by the toll authority, into a single billing eliminating multiple billings for multiple devices.

A further object is the notification to the toll authority the identification of a vehicle that has a specific AVI device attached, as this identity may change as vehicles are taken in and out of fleets.

A yet further object of the invention is to communicate to all proper authorities lost, stolen or defective AVI devices in order to terminate their use and accounting functionality.

Other objects and further scope of the applicability of the present invention will become apparent from the detailed description to follow, taken in conjunction with the accompanying drawings wherein like parts are designated by like reference numerals.

### SUMMARY OF THE INVENTION

A system and method to attribute, reconcile and account for automated vehicle identification (hereinafter referred to synonymously as “AVI”) charges irrespective of vehicle ownership. The practice of the subject invention is facilitated by first procuring a number of AVI tags containing encoded identification data and physically associating such procured tags with individual vehicles within a fleet of vehicles. A non-limiting example of such a vehicle fleet would be represented by vehicles typically leased or rented to retail customers by car or truck rental and leasing agencies. The invention allows for procurement of said tags by either a host reconciliation and accounting entity or second party procurement entity. In all instances, however, procured tags are registered with the host reconciliation and accounting entity for reconciliation and billing purposes. If procured by the host reconciliation and accounting entity, this entity in turn assigns a subset of such procured tags to a multiple vehicle leasing entity, such as a car or truck leasing or rental agency. The rental agency then physically associates each of the AVI tags assigned to it by the host reconciliation accounting entity with a specific vehicle, with the vehicle subsequently leased or rented to one or more drivers over varying periods of time. Should the tags be procured by a second party procurement entity, such as a multiple vehicle leasing operator, this procurement entity, after physically associating each procured tag with a vehicle within its fleet, communicates tag and vehicle identification information to the host reconciliation and accounting entity for registration purposes. Whenever a fleet vehicle possessing an associated AVI tag travels past an AVI tag monitoring location, the AVI tag is machine read at the location site. An example of such a location site would be a highway toll monitoring station. Periodically, information relating to the machine reading of the AVI tag and charges attendant therewith are communicated to the host reconciliation and accounting entity via a communications network. Such information is stored at the host reconciliation accounting entity's site in a specialized database format. The host reconciliation and accounting entity also acquires and stores daily vehicle activity records relating to the leasing or renting of vehicles possessing the vehicle assigned AVI tag from the leasing facility, and reconciles such daily activity records with toll charges communicated to the reconciliation accounting entity from the toll reading location, or other centralized information repository, thus obtaining a multiple of such toll charges. Once reconciled, the information is then formatted and communicated in the form of a billing statement to either the leasing entity, a company/entity responsible for payment, or to a credit card acceptance entity which can be either an individual or a business entity responsible for charges incurred by the identified driver for the time frame indicated. Payment associated with the afore noted billing statement is received by the host reconciliation and accounting entity where it is communicated either electronically or otherwise to a financial institution for deposit. An itemized record of the billing can be sent via e-mail (electronically) to the individual responsible for payment.

### BRIEF DESCRIPTION OF THE DRAWINGS

FIG. 1 is a system schematic providing a conceptual overview of the functional elements of the instant invention as practiced in its preferred embodiment.

FIG. 2 is a system schematic providing a conceptual overview of the functional elements of the instant invention as practiced in an alternative embodiment.

FIG. 3 is a processing flow diagram illustrating methodology steps of the instant invention as practiced in its preferred embodiment.

### DETAILED DESCRIPTION OF THE PREFERRED EMBODIMENTS

While the making and using of various embodiments of the present invention are discussed in detail below, it should be appreciated that the present invention provides for inventive concepts capable of being embodied in a variety of specific contexts. The specific embodiments discussed herein are merely illustrative of specific manners in which to make and use the invention and are not to be interpreted as limiting the scope of the instant invention.

The claims and the specification describe the invention presented and the terms that are employed in the claims draw their meaning from the use of such terms in the specification. The same terms employed in the prior art may be broader in meaning than specifically employed herein. Whenever there is a question between the broader definition of such terms used in the prior art and the more specific use of the terms herein, the more specific meaning is meant.

While the invention has been described with a certain degree of particularity, it is clear that many changes may be made in the details of construction and the arrangement of components without departing from the spirit and scope of this disclosure. It is understood that the invention is not limited to the embodiments set forth herein for purposes of exemplification, but is to be limited only by the scope of the attached claim or claims, including the full range of equivalency to which each element thereof is entitled.

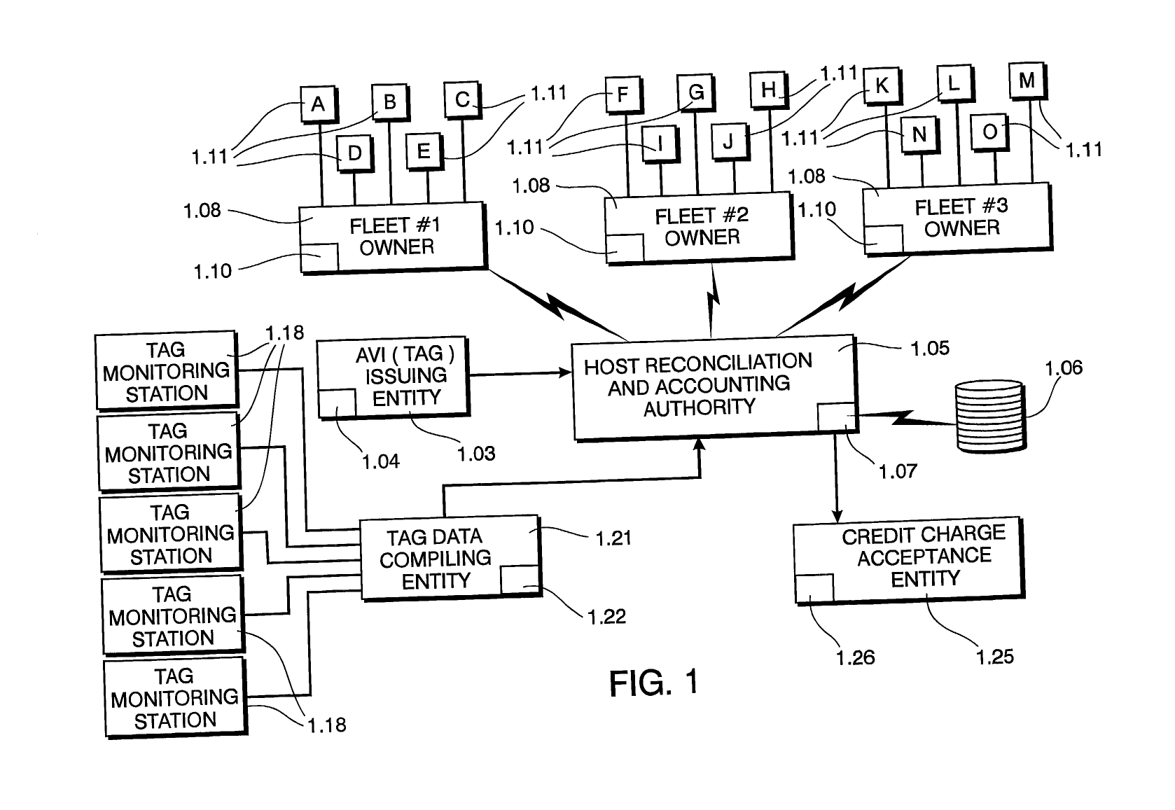

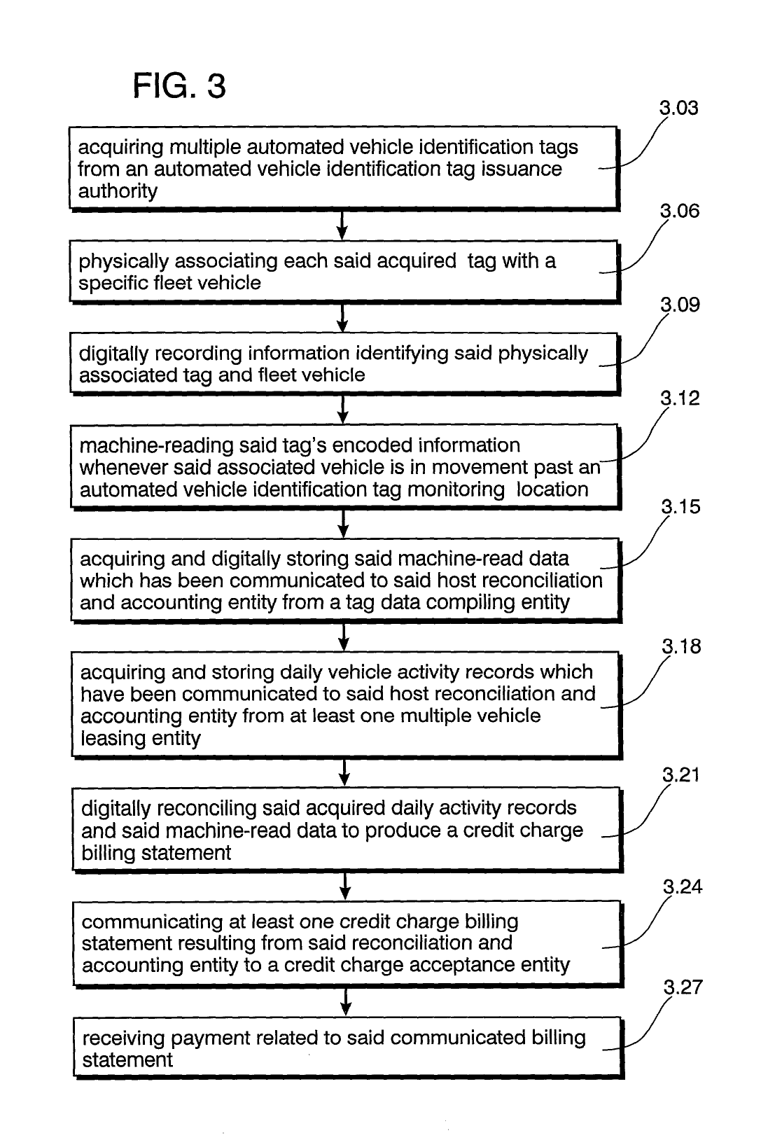

Referring to the drawings in detail, FIG. 1 is a system schematic providing a conceptual overview of the functional elements of the instant invention when practiced in its preferred embodiment. As can be seen in FIG. 1, the system is comprised of a host reconciliation and accounting authority 1.05 which is further comprised of a general purpose reconciliation computer 1.07 and at least one reconciliation process database 1.06. The host reconciliation and accounting authority 1.05 is communicably attached to a toll charge general purpose computer 1.22 which is, in turn, associated with a tag data compiling entity 1.21. The host reconciliation and accounting authority computer 1.07 is also communicably attached to a credit card acceptance entity general purpose computer 1.26 which resides within and is associated with a credit charge acceptance entity 1.25. As will be discussed in association with FIG. 3, the credit card acceptance entity 1.25 may be a business enterprise or an individual responsible for the acceptance and payment of credit card billing statements issued from the host reconciliation and accounting authority's general purpose computer 1.07. The host reconciliation and accounting authority 1.05 or more specifically, the host reconciliation and accounting authority's general purpose computer 1.07 is also communicably linked to one or more multiple fleet vehicle general purpose computers 1.10. Such computers 1.10 would typically reside within and under the processing control of one or more fleet vehicle owners such as car or truck rental or leasing operators 1.08. The communicable attachments referenced herein between said computers 1.26, 1.07, 1.10, 1.22 can be facilitated via any computer compatible communications network, such as but not limited to dial-up access, local area networks (LAN), wide area networks (WAN), campus area networks (CAN), metropolitan area networks (MAN), virtual private networks (VPN), the Internet or other digitally compatible communication infrastructure and transmission protocols well known and practiced by those skilled in the art.

An AVI tag issuing entity 1.03, such as a toll tag issuance authority or generic AVI device issuers such as TransCore, is also in communication with the host reconciliation and accounting authority 1.05. In practice, the tag issuing authority 1.03 either physically or via a digital communications link between its general purpose computer 1.04 and the host reconciliation authority general purpose computer 1.07, assigns a number of tags to the host reconciliation and accounting authority 1.05 whereupon such tags are suballocated to one or more fleet owners 1.08 for physical attachment of tags to one or more vehicles within their individual fleets 1.11. Utilization of the suballocated tags are recorded by tag monitoring stations 1.18 with aggregate usage information typically, though not necessarily, compiled at a tag data compiling entity 1.21 and communicated to the host reconciliation accounting authority via communication link established between a toll charge general purpose computer 1.22 and the host reconciliation accounting authority general purpose computer 1.07. Further information regarding physical tag/vehicle relationships is communicated between the fleet vehicle owner general purpose computer 1.10 and the host reconciliation and accounting authority computer 1.07 and will be discussed in association with FIG. 3. Acquired toll tag utilization and fleet vehicle usage information is reconciled via a reconciliation software means executing and adapting said reconciliation computer 1.07 to process and produce credit charge billing statements, which are electronically or physically communicated to the credit charge acceptance entity 1.25. Said electronic communication facilitated via a communications link between said reconciliation computer 1.07 and said credit charge acceptance entity computer 1.26. For purposes of a full and enabling disclosure, further discussion with respect to detailed disclosure of the invention's reconciliation processing steps will be discussed in association with FIG. 3.

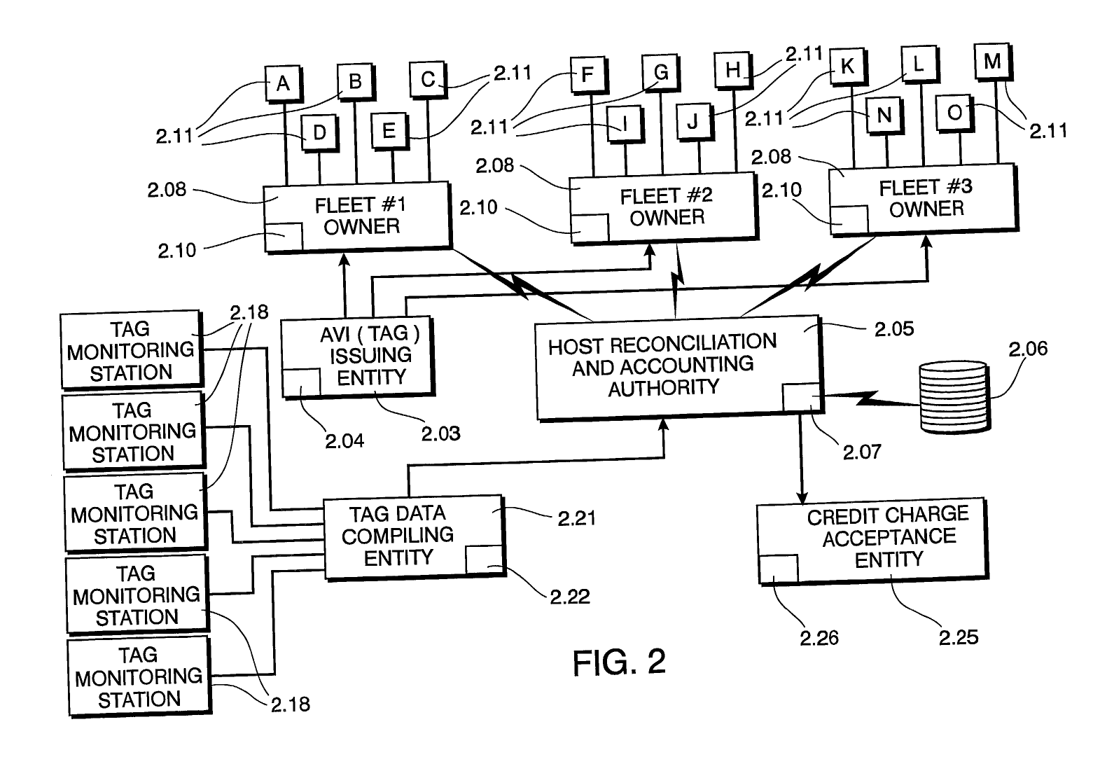

FIG. 2 illustrates an alternative embodiment of the present invention which is easily envisioned given benefit of the instant application's disclosure. In FIG. 2 an individual fleet owner 2.08 may simply acquire an isolated series of toll tags from the AVI issuing entity 2.03. Having once secured a tag allocation unique to the fleet owner's vehicles 2.11, the afore noted vehicle and toll tag physical association is made and such information is communicated to the host reconciliation and accounting authority 2.05 for registration purposes and to allow the billing statements discussed in association with FIG. 1, to be processed and issued.

FIG. 3 illustrates a processing flow diagram illustrating methodology steps of the instant invention as practiced in its preferred embodiment. As disclosed in FIG. 3, a plurality of automated vehicle identification tags are secured from an automated vehicle identification tag issuance authority 3.03. Such tags are secured to create a singular billing account and are issued either to a host reconciliation and accounting authority for subsequent suballocation to a rental fleet owner, or alternatively, directly to a rental fleet owner as previously discussed in association with FIG. 2. Once acquired, each tag is physically associated with a specific fleet vehicle 3.06 and internal accounts for each AVI tag are digitally established within the host reconciliation and accounting authority. Such information is typically stored in a host reconciliation and accounting authority database structure wherein the afore noted physical association is digitally recorded 3.09. In practice as the vehicle associated with each physically associated tag passes an automatic vehicle identification tag monitoring location the identifying information encoded within the physically associated tag is read 3.12. Over a predetermined interval of time, such as but not limited to a one month duration, the host reconciliation and accounting authority acquires the machine originally read data from at least one tag monitoring location 3.15. Such machine read data transmitted to the host reconciliation and accounting authority would include but not be limited to individualized tag identification information, the date and time of tag charge occurrence, the monitoring station tag cost assessment and any adjustments to monitoring station tag costs assessments. In its preferred embodiment, the invention assumes that such interval dependent machine read data has been collated at a tag data compiling entity prior to transmission to the host reconciliation and accounting authority. However, it is conceivable that in certain instances each tag monitoring location could transmit in a real time mode the currents of toll tag utilization charges and transmit such information to the host reconciliation and accounting authority from an individual tag monitoring station. The so acquired machine read data having been communicated to the host reconciliation and accounting authority from either an independent toll monitoring station or a tag data compiling entity is then stored within a database structure accessible to the host reconciliation and accounting authority general purpose computer.

The invention next acquires daily vehicle activity records from at least one multiple vehicle leasing entity 3.18. Such information without limitation comprises the date and time periods each vehicle is utilized and specific driver identification for each period of vehicle utilization, including, but not limited to, the driver's name, address, telephone number, and credit card identification information including but not limited to credit card number and expiration date information.

Having acquired and digitally storing said daily activity records from at least one fleet vehicle owner and said machine read data, the information is reconciled to produce a credit charge billing statement 3.21 whereafter said credit charge billing statement is communicated from reconciliation and accounting entity to a credit charge acceptance entity 3.24. As indicated in association with the discussion of FIG. 1, the credit charge acceptance entity may be either an individual responsible for acceptance and payment of said credit charges or a credit charge acceptance entity such as a credit card company. Should the credit charge acceptance entity have been determined to be a credit card company representing an individual or business enterprise, the instant invention then accepts payment relating to such communicated billing statement 3.27 either electronically or physically.

In addition to the credit charge billing information previously noted, the instant invention provides for advisory information which may be communicated between one or more general purpose computers. Such information includes, but is not limited to, the transmission of vehicle/tag identification number from the host reconciliation and accounting authority to a toll tag issuance authority, the transmission of AVI tag numbers on new/retired vehicles from a multiple fleet vehicle agency to the host reconciliation and accounting authority, the date, time and amounts of recorded tolls incurred by drivers of leased vehicles transmitted from the host reconciliation and accounting general purpose computer to a multiple vehicle fleet owner general purpose computer, and itemized detail of AVI tag usage to multiple fleet owner or individual drivers via e-mail. Thus providing in the instance of a credit charge billing to a credit card company, the customer with the ability to receive an itemized bill via e-mail in a monthly billing statement to “back up” his or her credit card company charges.

While this invention has been described to illustrative embodiments, this description is not to be construed in a limiting sense. Various modifications and combinations of the illustrative embodiments as well as other embodiments will be apparent to those skilled in the art upon referencing this disclosure. It is therefore intended that this disclosure encompass any such modifications or embodiments.

What is claimed is:

1. A method to attribute, reconcile and account for automated vehicle identification charges arising from a vehicle's usage, irrespective of said vehicle's ownership comprising:
(a) acquiring multiple automated vehicle identification tags containing encoded identification data from an automated vehicle identification tag issuance authority;
(b) physically associating each acquired tag with a specific fleet vehicle;
(c) digitally recording information identifying said physically associated tag and fleet vehicle;
(d) machine-reading said tag's encoded information while a vehicle is in movement past an automated vehicle identification tag monitoring location;
(e) acquiring and storing said machine-read data which has been communicated to said host reconciliation and accounting entity from at least one tag monitoring location;
(f) acquiring and storing daily vehicle activity records which have been communicated to said host reconciliation and accounting entity from at least one multiple vehicle leasing entity;
(g) reconciling said acquired daily activity records and said machine-read data;
(h) communicating at least one credit charge billing statement resulting from said reconciliation and accounting entity to a credit charge acceptance entity; and
(i) receiving payment related to said communicated billing statement.

2. The method of claim 1 wherein said multiple automated vehicle identification tags are acquired by a host reconciliation and accounting entity and further comprises the assignment of a subset of said automated vehicle identification tags to a least one multiple vehicle leasing entity.

3. The method of claim 1 wherein said multiple automated vehicle identification tags are acquired by a multiple vehicle leasing entity and further comprises the communication of tags and physically associated specific fleet vehicle identification information from said multiple vehicle leasing entity to said host reconciliation and accounting entity for registration.

4. The acquiring and storing of said machine-read data according to claim 1 wherein said data is first garnered from a plurality of tag monitoring locations and then communicated to said host reconciliation and accounting entity from a data compiling entity.

5. The method of claim 1 wherein said transmission of machine-read data to a host reconciliation and accounting entity includes information chosen from an information grouping including:
(a) individualized tag identification information;
(b) date and time tag charge occurrence;
(c) monitoring station tag cost assessment; and
(d) adjustment to monitoring station tag cost assessment.

6. The method of claim 1 wherein said acquiring of daily vehicle activity records for vehicles to which said tags have become associated includes records comprising:
(a) date and time periods each vehicle was utilized; and
(b) driver identification for each period of vehicle utilization.

7. The method of claim 6 wherein said driver information further comprises:
(a) said driver's name;
(b) said driver's address;
(c) said driver's telephone number; and
(d) said driver's credit card name, number and expiration date information.

8. The method of claim 1 wherein said credit charge acceptance entity is an individual responsible for payment of charges relating to said credit charge information.

9. The method of claim 1 wherein said credit charge acceptance entity is a business entity responsible for payment of charges relating to said credit card information.

10. The method of claim 1 wherein communicating said credit charge in formation resulting from said reconciliation and accounting entity to a credit charge acceptance entity, further comprises:
(a) communicating the name of a vehicle driver for a specific time and date;
(b) communicating tag usage charges for said time and date; and
(c) communicating said driver's credit card name, number, billing address and expiration date.

11. The method of claim 1 wherein said acquiring of said machine-read data and said daily activity records is facilitated via a computer compatible communications network.

12. The method of claim 1 wherein said communicating of credit charge information is facilitated via a computer compatible communications network.

13. The method of claim 1 further comprising:
(a) communicating vehicle identification information describing vehicles with which said tags have become physically associated from said reconciliation and accounting entity to a tag issuance authority;
(b) communicating lost or stolen associated tags from said reconciliation and accounting entity to a tag issuance authority;
(c) deactivating said communicated lost or stolen tags.

14. The method of claim 1 further comprising:
(a) communicating a billing statement from a tag issuance authority to said reconciliation and accounting entity;
(b) reconciling said communicated billing statement with tags issued to said reconciliation and accounting entity;
(c) communicating payment relating to said billing statement from said reconciliation and accounting entity to said tag issuance authority.

15. The method of claim 1 wherein said method further includes the calculation and addition of a processing surcharge fee to said reconciled daily activity records and machine read data.

16. The method of claims 1 and 10 wherein communicating said credit charge information further comprises communicating a rebate credit to said credit charge acceptance entity.

17. The method of claim 1 further comprising the transmission of accrued vehicle toll charges from said host reconciliation and accounting authority to said multiple vehicle leasing entity.

18. A system to attribute, reconcile and account for automated vehicle identification charges arising from a vehicle's usage, irrespective of said vehicle's ownership based upon specified user criteria comprising:
at least one general purpose reconciliation computer comprising a central processing unit and at least one video display unit and at least one input device communicably attached to said central processing unit, said video display and input device configured to facilitate user interaction with said central processing unit;
at least one toll charge general purpose computer communicably attached to said reconciliation computer;
at least one credit charge acceptance general purpose computer communicably attached to said reconciliation computer;
at least one multiple fleet vehicle general purpose computer communicably attached to said reconciliation computer;
at least one reconciliation process database in communication with said reconciliation computer, video display and input device, said database permitting said user to interactively specify said criteria;
reconciliation software means which executes and adapts said reconciliation computer to analyze data within said database based upon said criteria specified by the user via said video display and input devices, said software execution yielding credit charge billing information;
multiple fleet software means which adapts said multiple fleet computer to communicate fleet vehicle and tag information to said reconciliation computer;
toll charge software means which adapts said toll charge computer to communicate machine read data to said reconciliation computer;
a computer compatible network communication means capable of facilitating bi-directional transmission of digitized information between at least two general purpose computers of said system.

19. The system as recited in claim 18 wherein said general purpose computer, said video display, said input device and said database are communicably attached via a computer compatible communications network.

20. The system as recited in claim 18 where said reconciliation system further comprises the facilitation of multiple and essentially simultaneous user access, viewing and contingent control of said software's execution.

21. The system as recited in claim 18 wherein said input device is a computer keyboard or a computer mouse and said video display is a computer monitor.

22. The system as recited in claim 18 where said reconciliation software means further comprises yielding advisory information to be communicated to either said toll charge general purpose computer or said multiple fleet vehicle.
